(19) United States
(12) Patent Application Publication
(10) Pub. No.: US 2010/0151161 A1
(43) Pub. Date: Jun. 17, 2010

(54) FLEXIBLE HOLLOW SHAFT

(76) Inventor: Orlando Da Rolo, Solothurn (CH)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/089,142

(22) PCT Filed: Oct. 4, 2006
(86) PCT No.: PCT/US06/53629

§ 371 Date: Apr. 3, 2008

(30) Foreign Application Priority Data
Oct. 5, 2005 (CH) CH 2005 1605/05

(51) Int. Cl. B32B 1/08

(52) U.S. Cl. 428/34.1

(57) ABSTRACT

The invention relates to a flexible hollow shaft (1) that, by joining individual parts by dovetailed points of separation (1), reliably ensures the transmission of forces over radii.

The present invention relates to a flexible hollow shaft according to the preamble of patent claim 1.

Hollow shafts as drive shafts may be desired for various reasons. On the one hand, as compared with a solid shaft with the same diameter, a hollow shaft affords approximately the same possibilities for the transmission of torques, along with am appreciably lower weight. Another reason is that material can be transported away through the hollow body. This makes it possible for the first time to drill really long holes. The drilling material is flushed from the tool at the tip of the tube upward through the hollow shaft, for example by means of washing water. Typical applications of this type are therefore also depth bores for water or crude oil. The drilling material is discharged through the center of the tube, at the tip of which the drilling tool is located, by means of liquid introduced from above.

A completely different use for hollow shafts is, on a completely different scale, arthroscopic operating technology. Surgical cutting instruments, such as are presented in WO 00/45713 or in DE 44 22 426, are mounted at one end of two thin-walled tubes running one in the other. Such devices are employed with great success in arthroscopy since they are equipped, depending on application and use, with various cutting heads, cutting edges and orifices. Their popularity in use is attributable to the fact that corrections of pathological or accident-induced changes in joints can be carried out with minimal operative intervention and in a delicate way, without causing serious injury to tissue and muscles. A typical instrument of this type is presented in DE 44 22 426.

The design of cutting heads and cutting geometries is illustrated and described in detail in many applications. This surgical cutting instruments are always based on the technique of discharging the removed material through the tube.

As long as such tubes are straight, this does not present any major problems either for ground bores or for very much more delicate use in arthroscopy. The production of thin-walled tubes with a diameter in the range of a few millimeters is not a problem with the techniques and materials known today. The wish has now arisen, however, to have not only straight instruments, but also curved instruments with which work can be carried out “around the corner”. Ideas for the type of design of such curved cutting instruments for surgery are found, for example, in EP 0 445 918. One possibility in this direction for ground bores was shown as early as 1947 in U.S. Pat. No. 2,515,365. The disadvantage of the design according to EP 0 445 918 is to be found in that, between the slots allowing some flexible bending during rotation, the instrument has a large number of “bridges” which are bent and stretched in the elasticity range during each rotation. At the high rotational speeds of well above 1000 rpm/min for hollow shafts used surgically, the reversed bending loads on the bridges are enormous. The result is often a fracture of the hollow shafts. Devices manufactured according to this principle are therefore not reliable. The fracture of the “bridges” described above will occur precisely when the tool driven on a flexible hollow shaft should drill or cut with greater force.

One possibility for keeping this load on the bridges within reasonable limits is, of course, to keep as small as possible the angle at which bending takes place. The result of this is that the radius of the curve which the instrument equipped with such a hollow shaft may describe has to be relatively large. This means, on the other hand, that the length of the hollow shaft becomes greater, the larger the desired angle which the hollow shaft describes between the drive tube and the driven tube has to be. Narrow radii, by means of which niches can be coped with, therefore cannot be achieved by means of such designs.

The applicant of EP 0 445 918 recognized this and therefore made a further application EP 0 840 572 showing a novel type of design. For use in surgical cutting instruments, he used the principle employed in the field of ground bores and known since 1947 from U.S. Pat. No. 2,515,365 of Zublin. A spirally running dovetail-like arrangement of the slots is selected. However, there are, nevertheless problems in practice. Although the number of “bridges” which are subjected to reversed bending load is markedly reduced, they are not completely eliminated. The minimum radius which can be implemented is still relatively large. It allows an angling of approximately 30° for a flexible hollow shaft of this type of construction if a reasonable length of the device is to be obtained.

Another problem is the strength of such devices. It is very difficult to detect the forces arising in this complex design. Owing to the dovetail-shaped form-fitting and spiral arrangement of the slots, it is not clear where the locations in the structure which are subjected to the main load are to be found. It is therefore difficult to configure the structure at the correct locations according to the forces which arise. This results in uncertainty in the use of this flexible hollow shaft. It is known that the flexible hollow shafts designed in this way have broken during use.

These flexible hollow shafts are operated at rotational speeds of well above 1000 rpm. They run in encasing tubes. This means, for the fixed “bridges”, well above 1000 load changes per minute. Use lasts for 10 to 20 mins at high speed, and therefore up to 50000 load changes fatigue the material. Metals can cope with such bends in the elastic range to only a very restricted extent.

The set object according to the invention, then, is to construct the flexible hollow shaft, by means of which curves of more than 90° can be implemented, with radii of a few centimeters, without the material in this case being exposed to reversed bending load. This object must be fulfilled even when the instruments are employed with oscillations of 1000 to 8000 direction changes and with rotational speeds for forward and return running of 1000 to 16000 rpm. Hollow shaft designs known hitherto do not afford this possibility.

This object is achieved by the present flexible shaft having the features of Patent Claim 1. Further features according to the invention may be gathered from the dependent claims and their advantages are explained in the following description.

In the drawing:

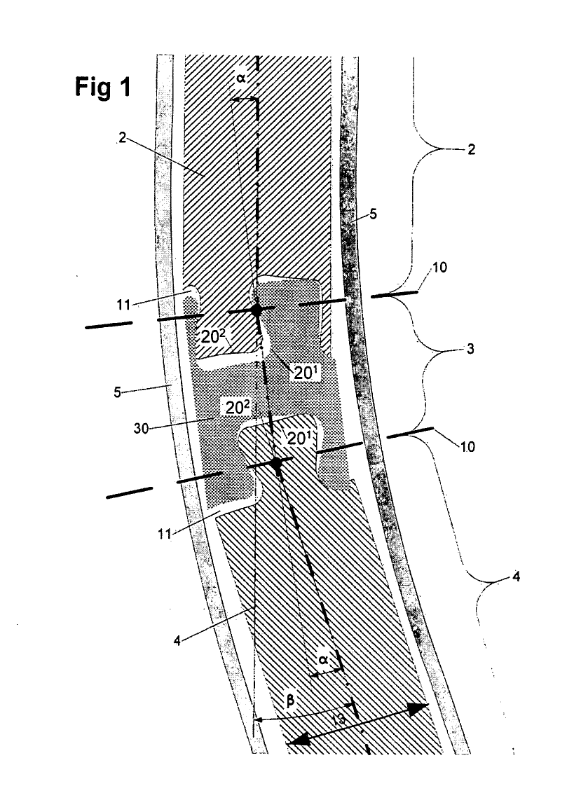

FIG. 1 shows a flexible hollow shaft with a middle tube element,

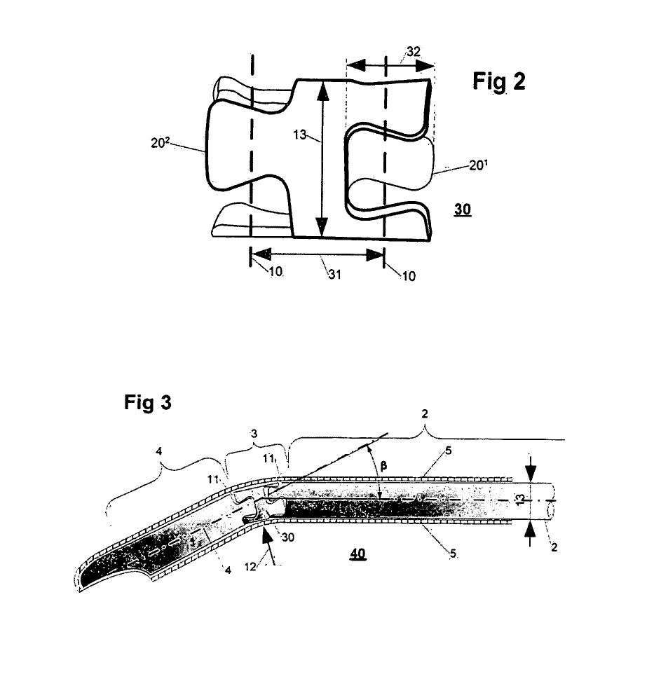

FIG. 2 shows a middle tube element,

FIG. 3 shows a surgical cutting instrument with flexible hollow shaft,

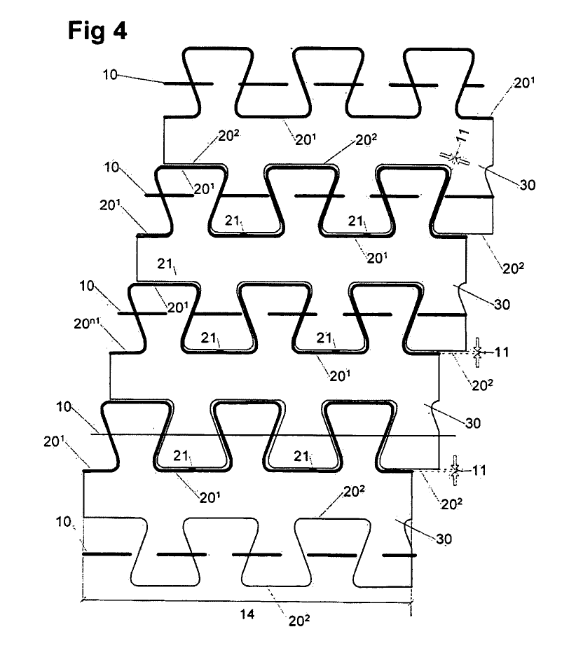

FIG. 4 shows an arrangement the dovetail connections,

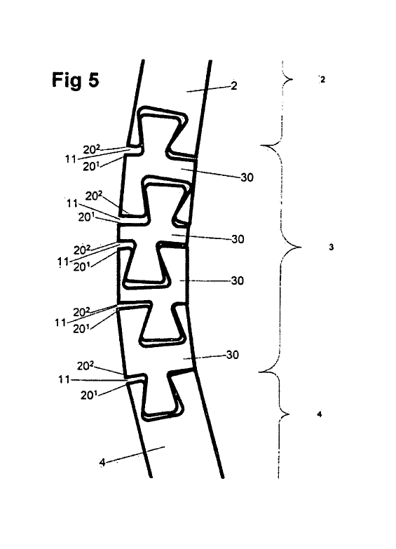

FIG. 5 shows a flexible hollow shaft with a plurality of middle tube elements,

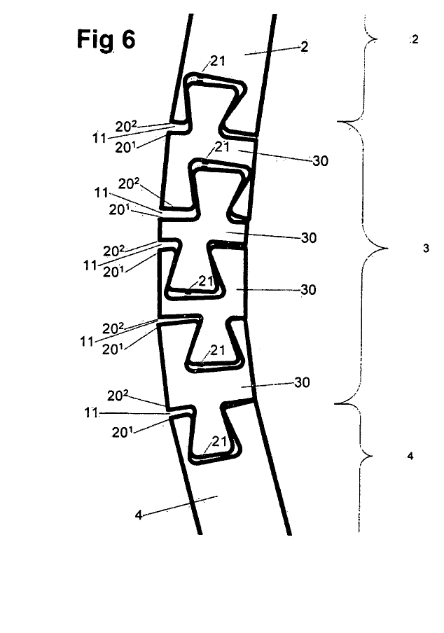

FIG. 6 shows a flexible hollow shaft with a plurality of middle tube elements connected by means of webs.

The figures illustrate preferred exemplary design proposals which are explained in the following description.

FIG. 1 shows a flexible hollow shaft 1 of the inventive type with a drive tube 2, with a middle tube 3 and with a driven tube 4, and also with a guide tube 5 encasing these elements. These parts basically have no fixed mutual connection and are designed as parts independent of and separated from one another.

The drive tube 2 has at one end a dovetail-shaped termination 20². At the other end, for example in the case of a surgical cutting instrument, is located a connecting part to a drive unit which by means of a turbine drive generates rotational speeds of well above 1000 rpm. When a hollow shaft of the inventive type is used, for example, for depth bores, the rotational speeds will have far lower rates of revolution.

The driven tube 4 has at one end a dovetail-shaped termination 20¹. For example, a tool is mounted at its other end as a driven part of the flexible hollow shaft 1. In the case of surgical cutting tools, this tool may comprise, for example, fine knives, as illustrated in FIG. 3. Tools for depth bores are equipped with drilling heads, such as are customary in this sector.

Tests have shown that the middle tube 3 may be dispensed with. The drive tube 2 and driven tube 4 are then directly in engagement with their terminations 20² and 20¹ matching one another with a form fit, and the achievable angle β corresponds to the achievable angle α which can be achieved by means of a separation.

As a rule, however, a middle tube 3 consisting of at least one middle tube element 30 is inserted between the drive tube 2 and driven tube 4. The middle tube elements 30 (FIG. 2) have at one end a dovetail-shaped termination 20¹ and at the other end a dovetail-Shaped termination 20². Each dovetail-shaped termination 20¹ fits in its form onto a dovetail-shaped termination 20², a rough form-fit connection with play 11 being obtained via which a torque can be transmitted.

The dovetail-shaped terminations 20² and 20¹ are formed around a theoretical separation point 10. The separating lines present in practice are wound in a dovetail-shaped manner along the circumference of the tubes and around this theoretical separation point 10. Depending on the given requirements, a play 11 of 0.01 and 0.5 mm is provided between the practical separation points, the dovetail-shaped terminations 20² and 20¹. This makes it possible that the longitudinal axes of the individual elements, drive tube 2, middle tube 3 and driven tube 4, can stand at an angle α to one another. If, then, the hollow shaft rotates, the play 11 “travels” along on the circumference of the dovetail-shaped terminations 20² and 20¹ and thereby makes it possible for the axes to rotate with respect to one another at the angle α, while the force transmission between the elements is ensured. It is not elasticity or even deformation of the metal, but, instead, the play 11 “traveling” along the circumference in the separation of the dovetail-shaped terminations 20² and 20² of the spherical separation point 10, which makes it possible to have the resulting “flexible bending” of the hollow shaft 1 via the middle tube 3 and ensures the desired force transmission.

So that the individual elements are guided, all the elements of the flexible hollow shaft 1 are held, supported and guided by the guide tube 5. The entire unit 40 (FIG. 3) consisting of the flexile hollow shaft 1 and of the guide tube 5 is curved at a fixed angle β. This angle β, which the instrument describes after its completion, is fixed and inflexible. However, the flexible hollow shaft 1 guided in the guide tube 5 makes it possible to transmit a torque “around the bend”. FIG. 3 shows use on a surgical cutting instrument 40. The flexible hollow shaft 1 of the type presented can bridge angles of up to 90° with small radii 12 of, for example, 5-10 cm and with rotational speeds of well above 1000 rpm.

This is a performance which can be achieved only by means of the presented design of the flexible hollow shaft. This is achieved in that the length 31 (FIG. 2) of the middle tube elements 30 and the height 32 of the dovetail-shaped, terminations 20 are adapted. Small radii 12 can be achieved by means of a multiplicity of short middle tube elements 30 which have small heights 32 of the dovetail-shaped terminations 20. For mechanical reasons, however, the minimum size of the middle tube element 30 is limited, depending on the diameter 13 of, the flexible hollbw shaft 1 (FIG. 2). It must also be noted that the order of magnitude of the angle α to be bridged depends on the number of middle tube elements used. The more middle tithe elements 30 are used, the larger will the angle β become since it is composed of the individual angles α between the individual elements.

The arrangement of the dovetail forms over the circumference of the hollow shaft, is as far as possible random. There is, however, the condition that a terminal 20¹ must always fit onto a termination 20², the terminations 20¹ of the driven tube 4 and 20² of the drive tube 2 in this case being designed as 20¹ and 20² respectively and haying to fit onto the terminations 20² and 20¹ of the adjoining middle tube elements 30.

One possibility for arranging the dovetail-shaped terminations 20¹ and 20² is shown in FIG. 4. The illustration shows a development of the individual middle tube elements 30 on the circumference 14 which corresponds to 3.14 times the diameter 13 of the tubes. The arrangements may be arbitrary. One requirement is that the terminations 20¹ and 20² must in each case fit one onto the other in pairs. This very illustration also illustrates how the play 11 between the individual middle tube element 30 is formed in the paired terminations 20¹ and 20². The terminations 20¹ and 20² of the driven tube 4 and drive tube 2 respectively form expediently a pair with the terminations 20¹ and 20² of the adjoining middle tube elements 30.

FIG. 5 shows the flexible hollow shaft 1 with the middle tuba 3 consisting of a plurality of middle tube elements 30, with the drive tube 2 and with the driven tube 4 in assembled form. In order to achieve quieter running when the flexible hollow shaft 1 is in use, the dovetail-shaped separating lines 20 of the middle tube elements 30 are not distributed regularly on the circumference as illustrated in FIG. 4, but are arranged randomly, as illustrated in FIG. 5.

An optimal play 11 between the drive tube 2, driven tube 4 and middle tube elements 30 is achieved in that the hollow shaft is caused to run in a guide tube 5 provided especially for this purpose. Tests have shown that, by the flexible hollow shaft 1 running in this way, the noise which it generates during operation is reduced considerably. At the same time, the play 11 between all the terminations 20¹ and 20² which are in engagement in pairs will also be adapted to the situation.

The hollow shaft 1 presented hitherto has a play 11 of 0.01 to 0.5 mm between the middle tube elements 30 or between the middle tube elements 30, the drive tube 2 and the driven tube 4. This play 11 makes it possible for the first time for the hollow shaft 1 to rotate in the guide tube 5. However, this results in the disadvantage that the play 11 gives rise in the curved position, on the outside diameter of the curve, to orifices which at least impede, if not even make impossible, the suction extraction which ensures backwash through the hollow shaft 1. In order to eliminate this, there are various methods which have been tried technically in tests and are implemented.

The flexible hollow shaft 1, before being introduced into the guide tube 5, may be dipped into a plastic melt, so that the parts of the hollow shaft 1 are covered with a flexible plastic coating. Since the play 11 comprises orifices in the region of a tenth of a millimeter, an averagely elastic material may be used for this purpose, which adheres to the material of the hollow shaft. A further possibility is to introduce into the hollow shaft 1 a hose consisting of elastic material and to press said hose by means of an expanding tool so that the material of the hose adheres to the material of the hollow shaft. The expanding tool may be an inflatable balloon-like device similar to those used for the expansion of narrowed coronary blood vessels.

Much the simplest method is to mount a hose around the hollow shaft and then encase it by means of shrinkage around the outside diameter of the hollow shaft. The advantage of this method is that the material shrunk on in this way adheres due to its inherent elasticity to the hollow shaft independently of the choice of material of the hose and hollow shaft. The hollow shaft 1 can be sealed off effectively by means of any of these measures described above.

For the production of the hollow shaft 1, a special method may be used which simplifies the production process and, above all, the handling of the hollow shaft during the production process: as illustrated in FIG. 4, webs 21 are installed between the individual parts of the hollow shaft 1. These are designed such that, during the first bending of the hollow shaft 1 which is to take place, in a guide tube 5, they break, without leaving traces behind on the parts of the hollow shaft 1. FIG. 6 shows how the remains of the broken webs 21 remain on the parts of the hollow shaft. The use of this method affords the advantage that it is perfectly possible to work in the production, process with straight cylindrical hollow shafts 1. Thus, for example, surface treatments of the already separated parts may take place in a simpler way in that the hollow shaft 1 has a straight and stable form. If the parts 2, 30 and 4 were already independent of one another in this phase, the processing of these parts 2, 30 and 4 held loosely one in the other would be difficult. Especially the introduction or encasing of the hollow shaft 1 with a flexible and elastic hose would also be very much, mote difficult.

In this case, the introduction of the hollow shaft 1 into the guide tube 5 takes place in the straight form of the hollow shaft 1 held by the webs 21. Ad soon as a curving of the hollow shaft 1 occurs, then, the predetermined breaking points will break. However, they break, at the latest, when the hollow shaft 1 used as a drive shaft begins to rotate at a high rotational speed in the curved guide tube 5.

The production of such webs 21 as predetermined breaking points presents no problem for the production techniques which can be employed today. All production methods, such as laser cutting; erosion or etching, make it possible not only to leave webs 21 standing, but also to bring these to the dimensioning necessary for use as predetermined breaking points.

1. Flexible hollow shaft, composed of a drive tube, of at least one middle tube and of a driven tube, wherein said drive tube (2), said middle tube (3), and said driven tube (4) are independent individual parts separate from one another.

2. A flexible hollow shaft according to claim 1, wherein said middle tube (3) consists of at least one middle tube element (30).

3. A flexible hollow shaft according to claim 2, wherein said individual middle tube elements (3) are parts independent of one another.

4. A flexible hollow shaft according to claim 1, wherein said drive tube (2), said middle tube (3) and said driven tube (4) are held and guided in a guide tube (5).

5. A flexible hollow shaft according to claim 1, wherein said middle tube elements (30) have a surrounding dovetail-shaped termination (20ⁿ¹), located on the theoretical separating line (10) running perpendicularly with respect to the axis on the circumference of the shaft, and said middle tube elements have at the other end a termination (20ⁿ²) fitting on to the first dovetail-shaped termination (20ⁿ¹) of a next middle tube element (30).

6. A flexible hollow shaft according to claim 5, wherein [sic] said dovetail-shaped terminations (20¹) are connected with a form fit to said dovetail-shaped terminations (20²).

7. A flexible hollow shaft according to claim 1, wherein said drive tube (2), on the side facing the middle tube (3), forms a dovetail-shaped termination (20²), located on a theoretical separating line (10) running perpendicularly with respect to the axis on the circumference of the shaft, said termination surrounding this theoretical separating line (10).

8. A flexible hollow shaft according to claim 1, wherein said driven tube (4), on the side facing the middle tube (3), forms a dovetail-shaped termination (20¹), located on a theoretical separating line (10) running perpendicularly with respect to the axis on the circumference of the shaft, said termination surrounding this theoretical separating line (10).

9. A flexible hollow shaft according to claim 7, wherein said dovetail-shaped termination (20²) of said drive tube (2) fits identically in form with the first dovetail-shaped termination (2ⁿ¹) of a first middle tube element (30).

10. A flexible hollow shaft according to claim 8, wherein said dovetail-shaped termination (20¹) of said driven tube (4) fits in identical form with the second dovetail-shaped termination (20ⁿ²) of a last middle tube element (30).

11. A flexible hollow shaft according to claim 2, wherein said second dovetail-shaped termination (20ⁿ²) of one middle tube (30) fits in identical form with the first dovetail-shaped termination (20ⁿ¹) of a next middle tube element (30).

12. A flexible hollow shaft according to claim 5, wherein a play (11) of 0.01 to 0.5 mm is present in each case between all the dovetail-shaped terminations which engage one into the other, terminations (20²) of said drive tube (2), the terminations (20ⁿ¹, 20ⁿ²) of said middle tube elements (30) and the termination (20¹) of said driven tube (4).

13. A flexible hollow shaft according to claim 1, wherein said flexible hollow shaft (1) has a plastic coating, said coating covering the drive tube (2), said middle tube elements (30) and said driven tube (4) and connecting these parts.

14. A flexible hollow shaft according to claim 1, wherein, inside the flexible hollow shaft (1), that is to say in said drive tube (2), in said middle tube (3) and in said driven tube (4), is fitted with a form fit a thin plastic hose running through all these parts in the inside diameter.

15. A flexible hollow shaft according to claim 12, wherein a plastic hose is put over said flexible hollow shaft (1), that is to say over said drive tube (2), over said middle tube (3) and over said driven tube (4), and said hose is located between the parts of said hollow shaft (1) and said drive tube (2), over said middle tube (3) and over said driven tube (4), and said hose is located between the parts of said hollow shaft (1) and said drive tube (5) and is fixedly connected to the parts of said hollow shaft (1).

16. A flexible hollow shaft according to claim 1, wherein said drive tube (2), all middle tube elements (30) and said driven tube (4), as individual parts, are initially connected by means of webs (21), said webs (21) breaking under the action of low force, so that said drive tube (2), said middle tube elements (30) and said driven tube (4) are independent pails on the occasion of the first rotation of the hollow shaft (1) in the curved guide tube (5).
